(19) United States
(12) Patent Application Publication
(10) Pub. No.: US 2013/0031497 A1
(43) Pub. Date: Jan. 31, 2013

(54) METHOD AND APPARATUS FOR ENABLING MULTI-PARAMETER DISCOVERY AND INPUT

(71) Applicant: Juha Henrik Arrasvuori, Tampere (FI)

(72) Inventor: Juha Henrik Arrasvuori, Tampere (FI)

(73) Assignee: Nokia Corporation, Espoo (FI)

(21) Appl. No.: 13/558,854

(22) Filed: Jul. 26, 2012

Related U.S. Application Data
(60) Provisional application No. 61/513,181, filed on Jul. 29, 2011.

(51) Int. Cl. G06F 3/048

(52) U.S. Cl. 715/764

(57) ABSTRACT

An approach is provided for enabling multi-parameter discovery and input. A user interface platform determines to generate a user interface presenting one or more representations of one or more parameters associated with at least one categorical dimension. The user interface platform also determines one or more manipulations of the one or more representations in the user interface. The user interface platform then processes and/or facilitates a processing of the one or more manipulations to select from among the one or more parameters, the at least one categorical dimension, or a combination thereof.

### RELATED APPLICATIONS

This application claims benefit of the earlier filing date under 35 U.S.C. §119(e) of U.S. Provisional Application Ser. No. 61/513,181 filed Jul. 29, 2011, entitled “Method and Apparatus for Enabling Multi-Parameter Discovery and Input,” the entirety of which is incorporated herein by reference.

### BACKGROUND

Service providers and device manufacturers (e.g., wireless, cellular, etc.) are continually challenged to deliver value and convenience to consumers by, for example, providing compelling network services. Often, operability of such network services rely on the user input interaction utilized to access the network services or the devices. User input interaction can be executed via interaction with a user interface. User interaction is limited by the design and configuration of the user interface. With the advent of devices and platforms capable of receiving inputs of various means—methods, processes, and approaches are required to support intuitive interaction. However, there still exists a need to have user interaction alternatives that span different user scenarios to allow efficient, intuitive, and enjoyable user interaction enabled by a user interface. As such, device manufacturers and service providers face significant technical challenges to providing efficient, intuitive, and enjoyable multi-parameter discovery and input.

One area of interest has been the development of alternative approaches to multi-parameter generation and execution implemented, for example, by a search tool or other executable function/action. Generation and selection of search terms can be tedious for a user. The search experience may tax the ability of the user to conceive unique combinations of search terms. When conducting an information search, the sheer volume and scope of available information can quickly overwhelm many device users. Such a search limits the productivity of useful search result. However, with the increase in available content and functions accessible to device users, service providers and device manufacturers face significant challenges to present content which is relevant for users by means that are easily and quickly understood. A search experience imparted by various information (e.g., user context, user location, storage metadata, media, etc.) available to the user at the time of a search focuses a search tailored to a user's specific needs. The relevant approaches to support search functionality may also be applied to all user activities actuated via a user interface. User interface interaction aims to be intuitive and support entertainment and educational application platforms.

### SOME EXAMPLE EMBODIMENTS

Therefore, there is a need for an approach for enabling efficient multi-parameter discovery and input.

According to one embodiment, a method comprises determining to generate a user interface presenting one or more representations of one or more parameters associated with at least one categorical dimension. The method also comprises determining one or more manipulations of the one or more representations in the user interface. The method further comprises processing and/or facilitating a processing of the one or more manipulations to select from among the one or more parameters, the at least one categorical dimension, or a combination thereof.

According to another embodiment, an apparatus comprises at least one processor, and at least one memory including computer program code for one or more computer programs, the at least one memory and the computer program code configured to, with the at least one processor, cause, at least in part, the apparatus to determine to generate a user interface presenting one or more representations of one or more parameters associated with at least one categorical dimension. The apparatus is also caused to determine one or more manipulations of the one or more representations in the user interface. The apparatus is further caused to process and/or facilitate a processing of the one or more manipulations to select from among the one or more parameters, the at least one categorical dimension, or a combination thereof.

According to another embodiment, a computer-readable storage medium carries one or more sequences of one or more instructions which, when executed by one or more processors, cause, at least in part, an apparatus to determine to generate a user interface presenting one or more representations of one or more parameters associated with at least one categorical dimension category. The apparatus is also caused to determine one or more manipulations of the one or more representations in the user interface. The apparatus is further caused to determine to generate a user interface presenting one or more representations of one or more parameters associated with at least one categorical dimension

According to another embodiment, an apparatus comprises means for determining to generate a user interface presenting one or more representations of one or more parameters associated with at least one categorical dimension. The apparatus also comprises means for determining one or more manipulations of the one or more representations in the user interface. The apparatus further comprises means for processing and/or facilitating a processing of the one or more manipulations to select from among the one or more parameters, the at least one categorical dimension, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of enabling efficient multi-parameter discovery and input, according to one embodiment;

FIG. 2 is a diagram of the components of a user interface platform for enabling efficient multi-parameter discovery and input, according to one embodiment;

FIG. 3A is a flowchart of a process enabling efficient multi-parameter discovery and input, according to one embodiment.

FIG. 3B is a flowchart of a process enabling efficient multi-parameter discovery and input, according to one embodiment operable by user context information.

FIGS. 4A-4F are diagrams of user interfaces utilized in the processes of FIG. 3, according to various embodiments;

FIG. 5 is a diagram of hardware that can be used to implement an embodiment of the invention;

FIG. 6 is a diagram of a chip set that can be used to implement an embodiment of the invention; and

FIG. 7 is a diagram of a mobile terminal (e.g., handset) that can be used to implement an embodiment of the invention.

### DESCRIPTION OF SOME EMBODIMENTS

Examples of a method, apparatus, and computer program for enabling efficient multi-parameter discovery and input are disclosed. As used herein, parameter may include, for example, text or icon based keyword, search term, operator, function, command, executable action, or combination thereof. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term categorical dimension refers to the dimensional representation by which one or more parameters and/or categories or parameters are presented about a user interface. For example, a set or category of parameters may be grouped and/or presented in one categorical dimensional. In this way, multiple dimensions or categories of parameters may be presented for input as described in the various embodiments; each categorical dimension can then represent different keywords, characteristics, factors, etc. available for input. In addition, although various embodiments are described with respect to user interface platform, it is contemplated that the approach described herein may be used with other platforms for enabling multi-parameter discovery and input.

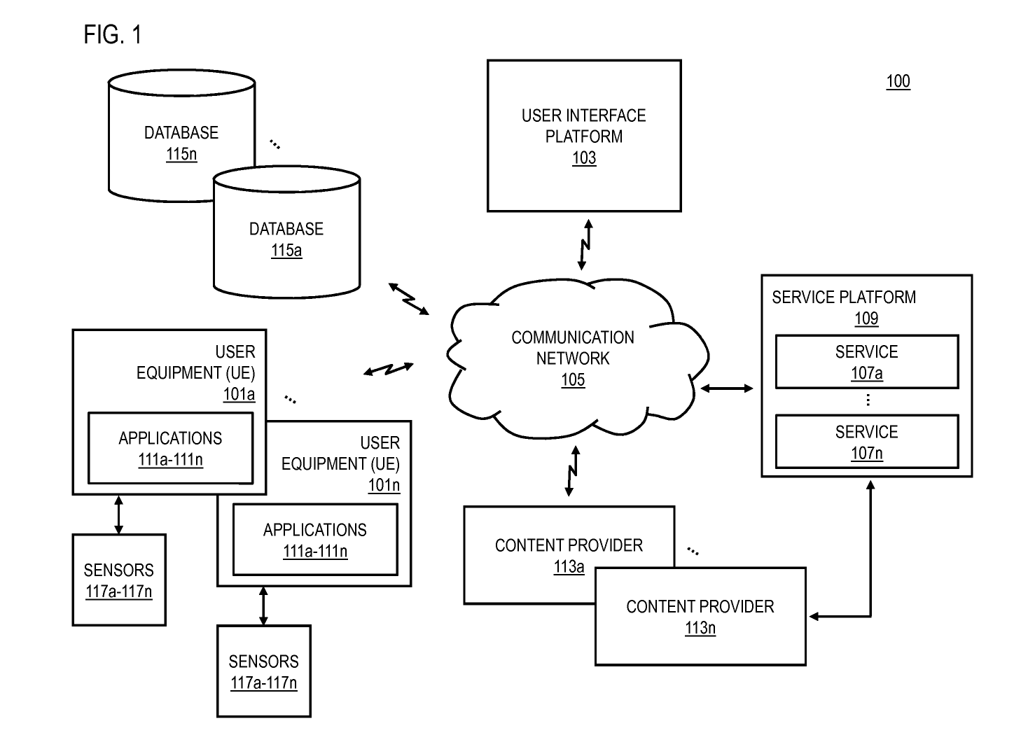

FIG. 1 is a diagram of a system capable of enabling efficient multi-parameter discovery and input, according to one embodiment. As discussed above, user interaction with services and devices is limited by the design and configuration of the user interface. With the advent of devices and platforms capable of receiving inputs of various means—methods, processes, and approaches are required to support intuitive user to user equipment interaction. The user interaction experience may tax the ability of the user to conceive of practical means to access information and employ executable commands. For example, when conducting an information search, the sheer volume and scope of available information can quickly overwhelm many device users. Such limitations adversely affect user interaction. As such, there still exists a need to have user interaction alternatives that span different user scenarios to allow efficient, intuitive, and enjoyable user interaction supported by a user interface.

To address this problem, a system 100 of FIG. 1 introduces the capability to enrich and enhance user input interaction on user equipment by enabling a user input interaction to be performed based on intuitive presentation of parameter combination inputs. The system 100 also provides a framework for presenting and rendering multidimensional combinations of keywords that are operable to execute a function. The system 100 also introduces a user interface to provide a more fluid and less user demanding user interaction experience to enable efficient multi-parameter discovery and input.

As shown in FIG. 1, the system 100 comprises a user equipment (UE) 101a-101n (collectively referred to as UE 101) having connectivity to a user interface platform 103 (discussed in detail below) via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In certain embodiments, one or more parameters (e.g., keywords, terms, executable commands, etc.) from two (or more) categories are represented according to a categorical dimension as a user interface. The arrangement adopts various configurations (e.g., two (or three) dimensional X/Y (and Z) grid, coordinate configuration, field configuration, 3D overlay configuration) The user initiates a user input interaction by selecting (or executing) a combination of two (or more) parameters by pressing a point on a touch screen user interface on the surface of UE. By pressing simultaneously multiple points, the user selects (or executes) multiple combinations of parameter pairs. By performing a user input initiation interaction, such as a “flicking” or “strumming” gesture on a touch screen, the selected parameters are executed. Optionally, the operable command is performed already in the background immediately when the user has pressed a point on the user interface, but the resulting action of the operable command is shown only when the initiation interaction has been performed by the user. The resulting action of the user input interaction is displayed, for example, on the user input UE itself, or on a third party UE, and/or communicated to a service platform, and/or content provider, and/or database, or a combination thereof. In addition, the user interface may be presented on a plurality of devices. Manipulations on any of the devices presenting the user interface may control the functionality of any or all of the respective devices.

In certain embodiments, a user interaction input interface functions as an integrated interface tool to perform at least the distinct functions of parameter definition, user input platform, and processing platform. The user interaction input interface is integrated via network communication such that each of the distinct functions are localized in the native UE, communicated via the network or networks to third party User Equipment(s), or a combination of native UE and third party User Equipment(s), database(s), content provider(s), and service platform(s). In certain embodiments, a user interaction input interface functions as part of a multi-touch parameter selection interface enabling efficient multi-parameter discovery and input.

In certain embodiments, a user interaction input interface functions in part with and/or as a parameter presentation and/or parameter generation and/or parameter determination platform. In certain embodiments, parameters are selected and/or entered by a user or users. In certain embodiments, parameters are derived and/or generated from stored information acquired from any available data accessible by the communication network(s). For example, parameters are derived from storage and/or applications native to or accessible from User Equipment(s), content provider(s), service platform(s), and storage database(s) accessible by a user, or a combination thereof. The storage database, for example, includes media with associated meta-data. The associated meta-data or alternative forms of information is presented as parameters or provide the thematic foundation or context by which parameters are presented.

For example, the information associated with stored and/or accessible data is processed to provide users with useful intuitive parameters. For example, accessible data is processed to derive practical themes for suggested parameters. Users may focus the parameters presented to suit a specific scenario by selection, or the process of selection is automated to encourage ease of use or useful suggestion constructs. Further, in some embodiments, parameters are presented for selection and/or display according to thematic and/or hierarchical lists. Themes are presented, suggested, and or entered to accord with user requirements. For example, themes are based on user context, location, prior use, modalities (e.g., productivity, lifestyle, entertainment, travel, games, educational, etc.), and/or third party suggestions communicated via the network. Further, in some embodiments, parameters are purely random or merely randomized in order to provide an alternative to user generated and/or selected parameters.

In certain embodiments, a user interaction input interface supports, enables and/or is an integrated component of a search function and/or search platform. The user manipulates the interface by entering inputs using the interaction interface to initiate a search of all available information on the native device and/or accessible network(s). In certain embodiments, parameters selected for search may be treated as a Boolean search utilizing Boolean operators. For example, an implementation using multiple pairs of parameters as keywords (e.g. “Food”&“Paris”, “Parks”&“Lyon”) to retrieve multiple results. Further, for example, an implementation combining all the parameters as keywords in a single search string or query (e.g. “Food AND Paris AND Parks AND Lyon”) to retrieve a single result. Further, other Boolean operators may be utilized in the search string such as, but not limited to “OR”.

In certain embodiments, a user interaction input interface supports executable system actions, commands, operators, functions, or a combination thereof. The user manipulates the interface by entering inputs using the interaction interface to initiate an executable system action actionable at any of the system components.

By way of example, the UE 101a-n, the user interface platform 103, the content provider 113a-n, the service platform 109, and the database (115a-n) communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

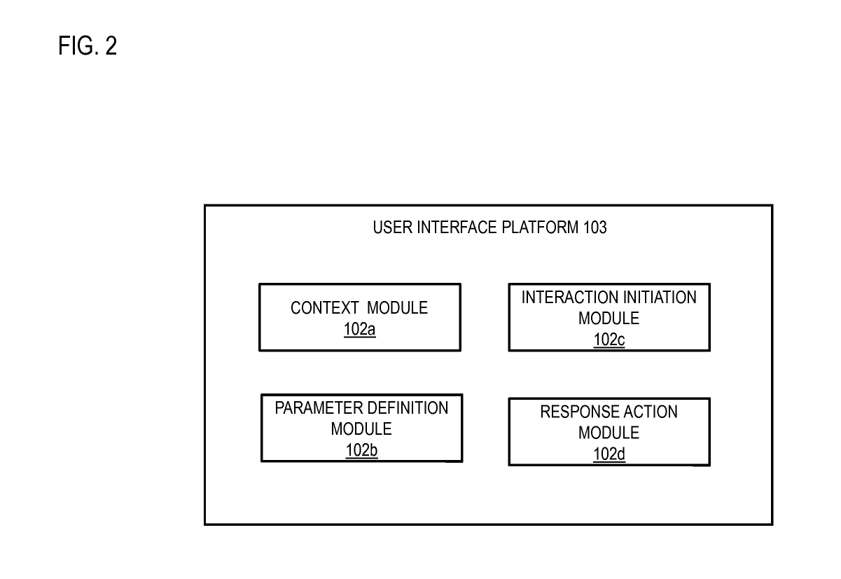

FIG. 2 is a diagram of the components of user interface platform 103, according to one embodiment. By way of example, the user interface platform 103 includes one or more components for enabling efficient multi-parameter discovery and input. It is contemplated that the functions of these components may be combined in one or more components or performed by other components of equivalent functionality. For example, the functions of these components may be embodied in one or more applications 111 executed on a UE 101. Alternatively, the functions of these components can be embodied in one or more modules of the UE 101, or one or more services 107 (or 107a-107n) on the service platform 109.

The context module 102a determines the context associated with a user of a UE 101 and/or an alternative UE or a plurality of devices accessible via the communication network 105. The context may comprise, for example, the current location of the user, a future location of the user based on one or more mapping applications 111 (or 111a-111n) running on the UE 101, a current or future appointment based on one or more calendar applications 111 running on the UE 101, etc. The context module 203 can determine the context from, for example, one or more applications 111 running on the UE 101, one or more modules of the UE 101, one or more sensors 117 (or 117a-117n) associated with the UE 101, one or more services 107 associated with the UE 101, or any combination thereof. The context module 102a can also determine the context associated with the users and/or the UE 101 based on interaction information at a user interface of the UE 101. For example, the UE 101 may include user interfaces that allow the users of the UE 101 to enter context regarding the users and/or the UE 101.

In one embodiment, the context module 102a continuously, periodically, or a combination thereof, determines the context information of the user and/or the UE 101 before and after a user interface interaction.

The parameter definition module 102b allows multiple parameters (e.g., keywords, terms, executable commands, etc.) to be rendered about a user interface on UE 101. Parameters may be defined by many different constructs. Parameters, for example, may be entered by the user or selected by the user, for example, from hierarchical lists and/or drop down menus. For example, user entered parameters are achieved by such means as a user typing, speaking, motioning, and by alternative communication means, or a combination thereof. For example, user selected parameters are achieved by such means as a user selecting a higher-level parameter to define lower-order parameters (e.g. “Pantherinae” that includes a set of more detailed parameters like “Tiger”, “Lion”, “Jaguar”, “Leopard”, each of which is assigned to one of numerous loci about at least one categorical dimension to define a user interface).

Further, in certain embodiments, parameters may also be selected from graphical displays such as maps (especially when geographic locations and points of interest (POIs) are relevant) or even from media items like photos or music. Graphical displays and media may be stored locally on the native device or generated/derived from any network accessible UE, content provider, database, service platform, or a combination thereof. Parameters derived from such stored data may be generated from any data-associated information, for example, photo titles/categories, photo-associated metadata such as geo-tags, song content lyrics, or a combination thereof. Further, in certain embodiments, parameter definition is influenced by user context, as discussed above.

The interaction initiation module 102c, determines the nature of a user interface initiation interaction. An actionable response may be the related result of any user interaction with UE. A user may physically interact with a UE, for example, by manipulating the user interface rendered on UE. Interaction initiation manipulation includes, but is not limited to, for example, touch and/or multi-touch.

In certain embodiments, a user may physically touch a rendered parameter to initiate a responsive action. Further, in certain embodiments, a user may initiate an action by interacting with a user interface in any way detectable by a UE. In certain embodiments, in applications not limited to entertainment, but inclusive of, various user gestures function as interaction initiation manipulation. Such gestures include, but are not limited to strumming (like when playing guitar), flicking or swiping (as associated with games, sports, etc.), abrupt changes in UE location (e.g. UE swinging, movement from static position, dropping, etc.), or a combination thereof. In certain embodiments, a combinatorial user interaction configuration relying on multiple gestures is required to initiate a user action.

In certain embodiments, for example, a step-wise configuration for user interaction initiation may be employed (i.e. a touch (or multi-touch) manipulation paired with a gesture, wherein each step or action generates a particular actionable response, or a combination of touch and gesture is required to initiate an actionable response). For example, a user selects at least one set of parameters rendered about a user interface by touching an associated point or coordinate graphically represented on a user interface. A user may touch additional points or coordinates; each user touch effectively selects a parameter set. Each user touch may initiate a UE action. Or, in certain embodiments, a step-wise configuration requires a gesture or some type of further user interaction with a user interface to initiate an action. Or, in certain embodiments, each user interaction creates a discrete action, wherein each action may be related or distinct. Such user interaction may be executed by multiple users on a plurality of devices.

The response action module 120d, renders an action in response to a user initiation interaction. A response action may be caused, at least in part, by an interaction with a user interface. The response action may occur at the native device rendering the user interface receiving a user interaction, at any component of the user interface platform 103, at UE 101a-n, at database 115a-n, at content provider 113a-n, at service platform 109 a-n, at any communication receivable attribute connected via communication network 105, or any combination thereof.

By way of example, a response action is the resulting action wherein a user interaction is either a proximal (i.e., direct) or distal (i.e., indirect) cause. In certain embodiments, a response action may include, for example, a search for information stored locally or stored network accessibly, an actionable command (e.g. application launch and/or action, function control, etc.), an entertainment action (e.g., producing an instrument sound, such as a guitar sound, a sport or game-related action, etc.), a communication via a network, or a combination thereof.

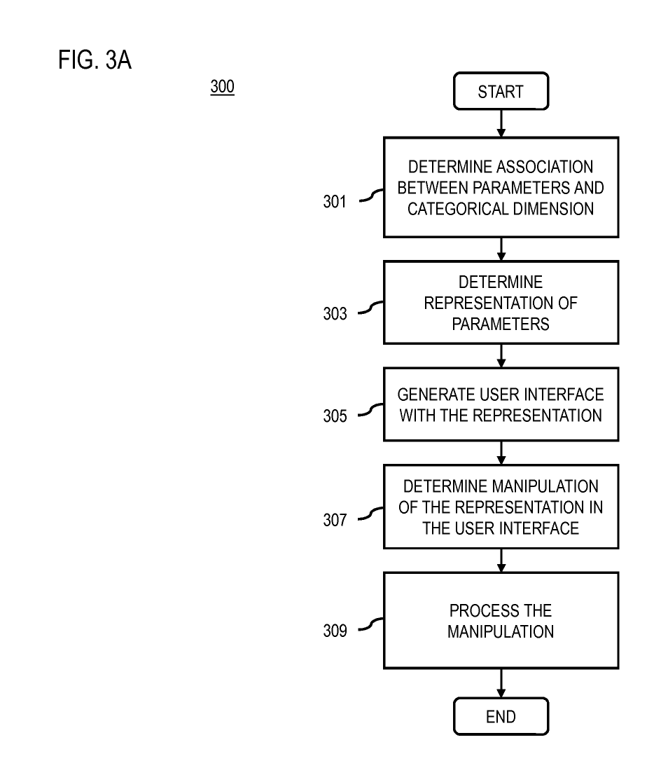

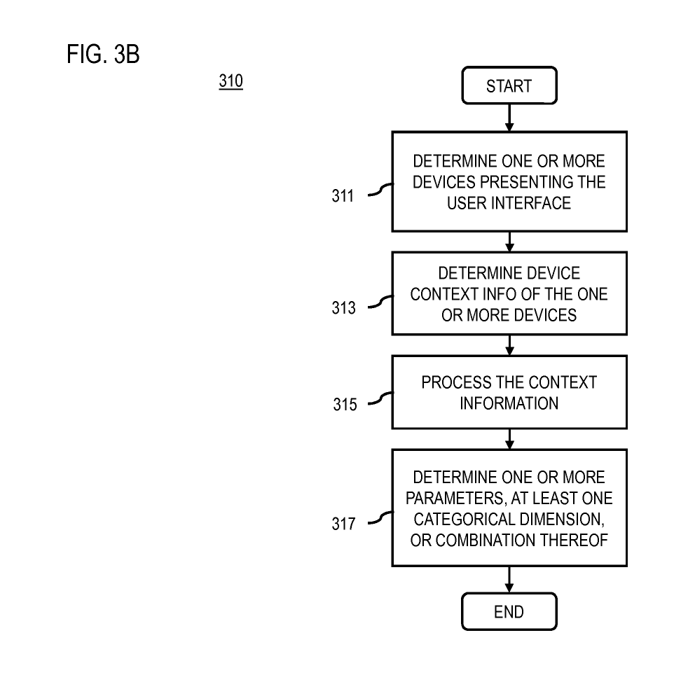

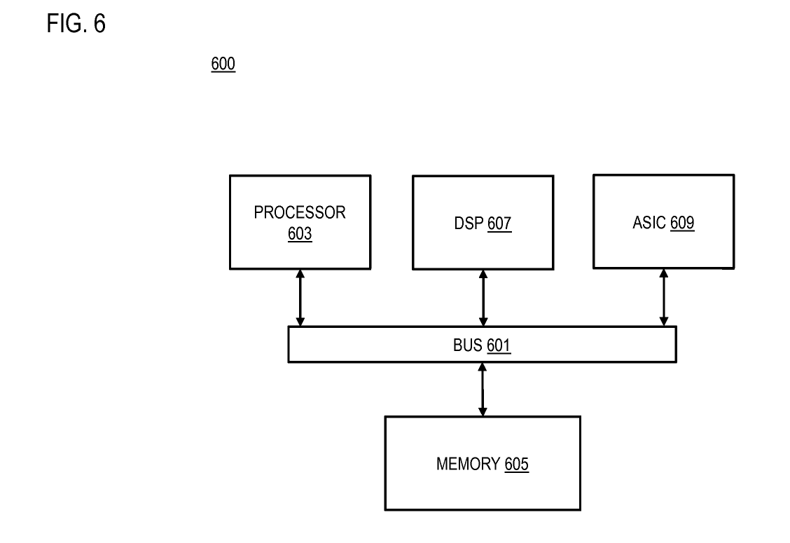

FIG. 3A is a flowchart of a process for enabling efficient multi-parameter discovery and input, according to one embodiment. In one embodiment, the user interface platform 103 performs the process 300 and is implemented in, for instance, a chip set including a processor and a memory as shown in FIG. 6.

In step 301, an association is determined between one or more parameters and at least one categorical dimension. By way of example, in one use case where the one or more parameters are keywords related to a location-based search, keywords for describing one or more characteristics of a point of interest (POI) (e.g., a POI type such as restaurant, shopping, entertainment, etc.) can be grouped and/or otherwise associated with one categorical dimension. In one embodiment, the user interface platform 103 determines the one or more parameters, the at least one categorical dimension, or a combination thereof based, at least in part, on a user-generated list, a predetermined list, a random selection, or a combination thereof. In other embodiments, the user interface platform 103 can dynamically generate a set of keywords and/or categorical dimensions as needed (e.g., as described in the process of FIG. 3B below). For example, the platform 103 can perform a semantic analysis of user search histories, documents, metadata, preferences, activities, service databases, etc. to determine appropriate keywords. As noted previously, the categorical dimension can be used to organize or define an overall category, label, grouping, etc. for related keywords.

In step 303, one or more representations of the one or more parameters are determined. In one embodiment, the one or more representations include icons, graphics, figures, symbols, and/or any other user interface elements that can represent the keywords and/or categorical dimensions. By way of example, the one or more representations can be determined based on user preferences, one or more selected themes, service provider preferences, etc. In step 305, the user interface platform 103 determines to generate a user interface presenting one or more representations of one or more parameters associated with at least one categorical dimension. In one embodiment, the user interface platform 103 causes, at least in part, a rendering of the one or more representations in the user interface as at least one musical instrument interface, at least one grid interface, at least one karaoke interface, at least one media player interface, at least one educational tool interface, at least one game interface, at least one roulette table interface, or a combination thereof.

In step 307, the user interface platform 103 determines one or more manipulations of the one or more representations in the user interface. By way of example, the manipulations are determined based on user interactions with respect to the representations (e.g., selecting, clicking, moving, dragging, pressing, etc. the one or more representations). Depending on theme of the user interface (e.g., musical instrument, grid, etc.), the types of available manipulations or interactions can be determined. For example, the user interface can present the keyword representations as keys of a plano keyboard, thereby enabling the user to interact with multiple keys representing one or more keywords to make a selection from among the keywords. In one embodiment, the user interface platform 103 determines to present the user interface on a multi-touch enabled device. In this case, the one or more manipulations comprise, at least in part, interaction information with one or more points on the multi-touch enabled device. In another embodiment, the user interface platform 103 can cause, at least in part, a presentation of the user interface on a plurality of devices. In this case, the one or more manipulations are determined with respect to the plurality of devices. In other words, manipulations or interactions at two different devices can be used to interact and select parameters. For example, multiple devices can have differently themed user interfaces (e.g., one device with a guitar them, another device with a plano theme, etc.). The devices can then be operated by separate users whose combined manipulations or interactions can be captured for processing.

In step 309, the user interface platform 103 processes and/or facilitates a processing of the one or more manipulations to select from among the one or more parameters, the at least one categorical dimension, or a combination thereof. In one embodiment, the processing includes, for instance, processing of manipulation or interaction information (e.g., at a multi-touch device) to determine one or more coordinates, one or more frequencies, one or more touch-pressure levels, or a combination thereof of the one or more manipulations. The user interface platform 103 can then determine one or more rendering characteristics of the user interface, the one or more representations, or a combination thereof the one or more based, at least in part, on the one or more coordinates, the one or more frequencies, the one or more touch-pressure levels, or a combination thereof. In yet another embodiment, the coordinates, frequencies, touch-pressure levels, etc. can be used to determine relative weighting of the selected parameters or keywords.

In one embodiment, the user interface platform 103 can cause, at least in part, an initiation of at least one action, at least one function, or a combination thereof based, at least in part, on the selected one or more parameters, the selected at least one categorical dimension, or a combination thereof. In another embodiment, the user interface platform 103 can process the one or more manipulations to determine at least one initiation interaction, wherein the initiation of the at least one action, the at least one function, or a combination thereof is based, at least in part, on the at least one initiation interaction. In this embodiment, the initiation interaction is differentiated from the selection interaction (e.g., interaction for selecting keywords). For example, the initiation interaction may include, for instance, strumming of a guitar-based interface to trigger a corresponding action, function, etc. (e.g., a search based on selected parameters).

FIG. 3B is a flowchart of a process for enabling efficient multi-parameter discovery and input, according to one embodiment. In one embodiment, the user interface platform 103 performs the process 310 and is implemented in, for instance, a chip set including a processor and a memory as shown in FIG. 6. In one embodiment, the process 310 describes a process for dynamically generating keywords or candidate parameters for presentation as described the various embodiments discussed herein.

As described above in the process 300 of FIG. 3A, the user interface platform 103 can present one or more user interfaces for multi-parameter input on a plurality of devices that can work either independently or cooperatively to determine parameters. Accordingly, in step 311, the user interface platform 103 can identify or otherwise determine the one or more devices that are presenting such a user interface. By way of example, this determination can be made via peer-to-peer signaling (e.g., via short-range wireless radio such as Bluetooth, WiFi, etc.) or via a client-server interaction with a backend system. Next, the user interface platform 103 can determine context information associated with the one or more devices presenting user interface. In one embodiment, context information may include search history, location, time, activity, and the like associated with the devices (step 313).

The user interface platform 103 then processes and/or facilitates a processing of the context information (step 315) to determine the one or more parameters, the at least one categorical dimension, or a combination thereof (step 317). For example, if the context information includes location information, the user interface platform 103 can dynamically determine or filter for keywords or parameters that are appropriate to the particular location. For example, if a user's context indicates that the user device is currently at the office, the user interface platform 103 can present parameters, keywords, categorical dimensions, etc. that are, for instance, topically relevant to the office. Similarly, it is contemplated that any other type of context information can be used or processed to determine contextually relevant parameters.

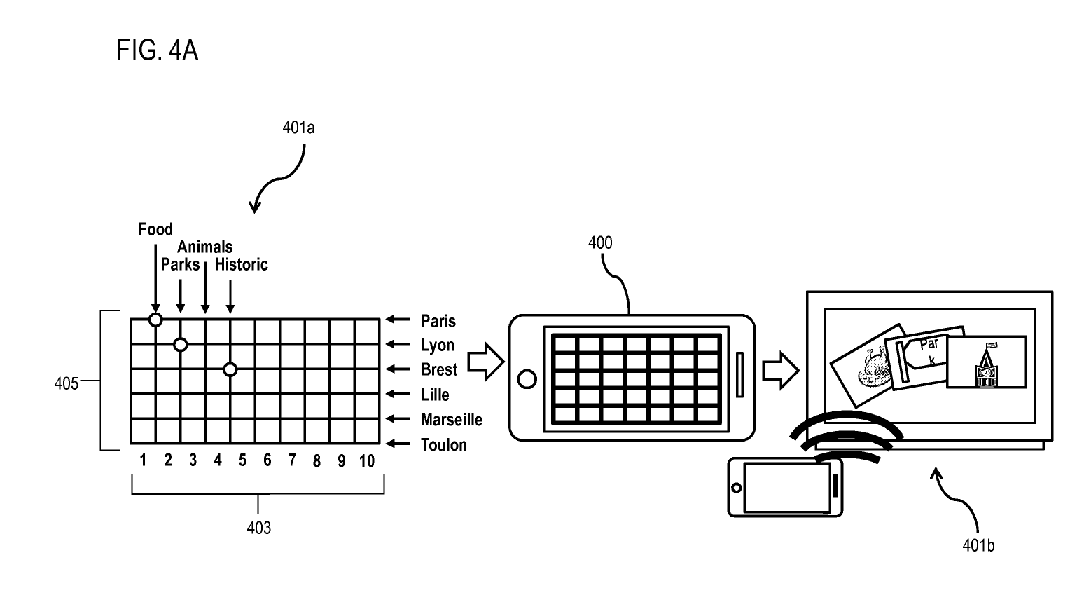

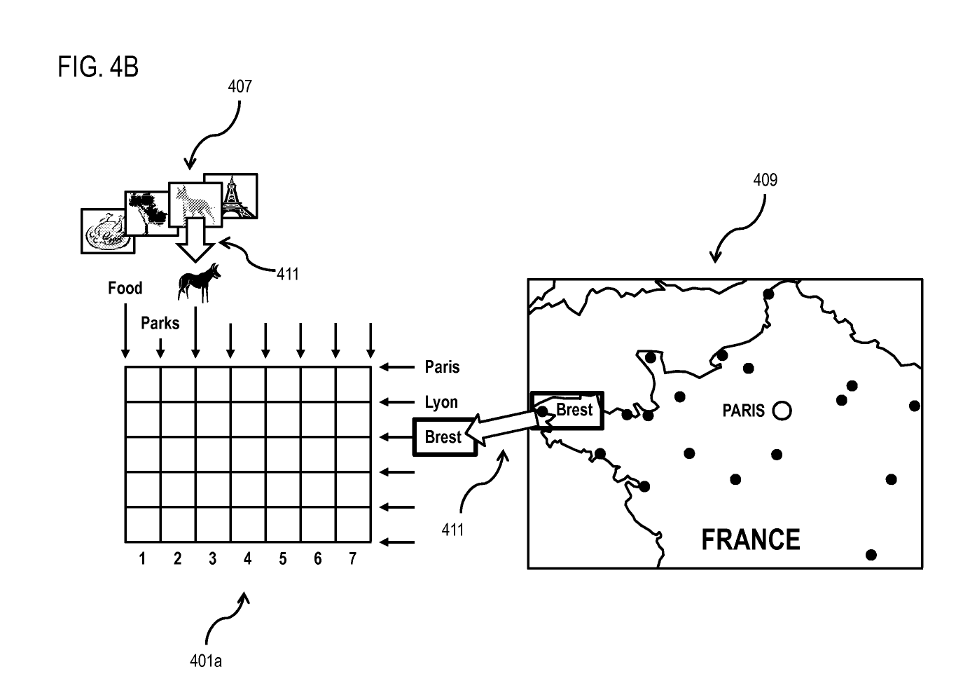

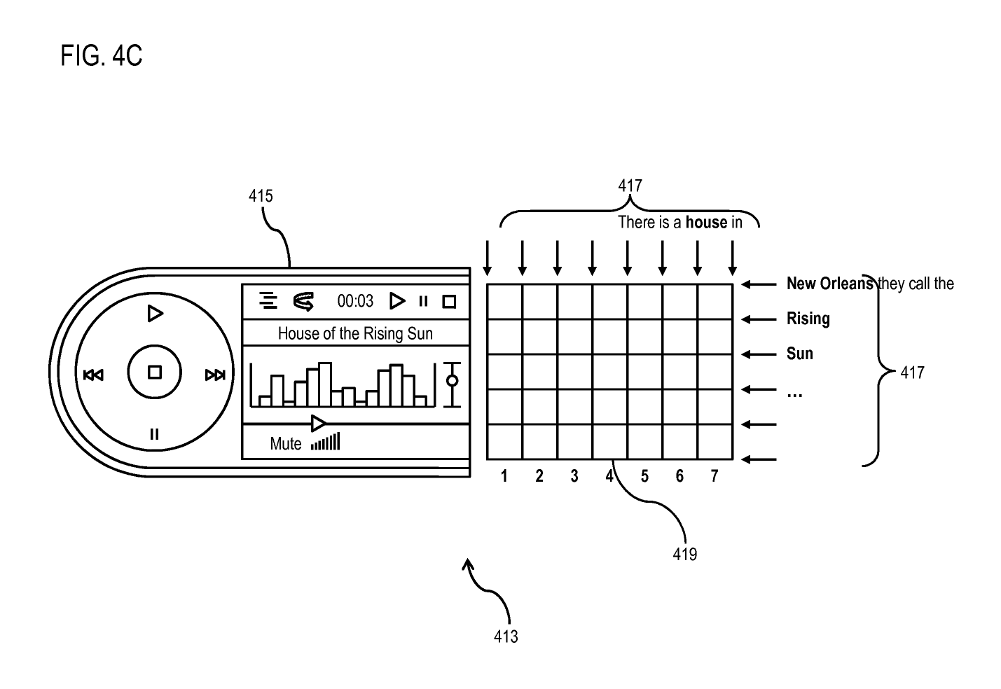

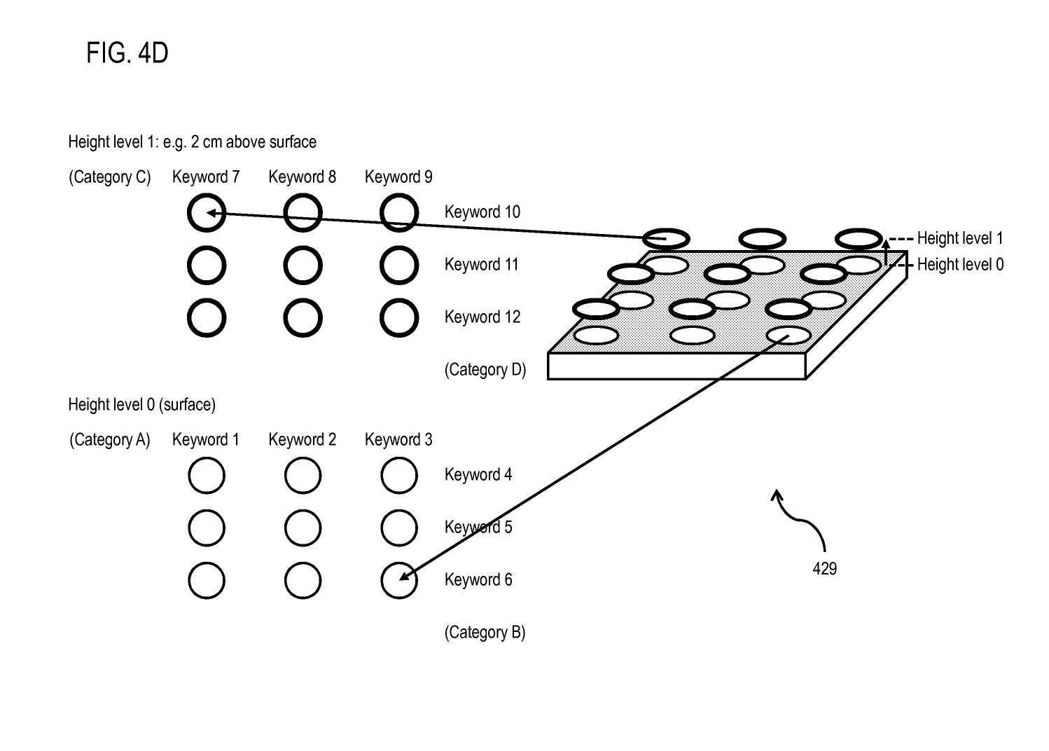

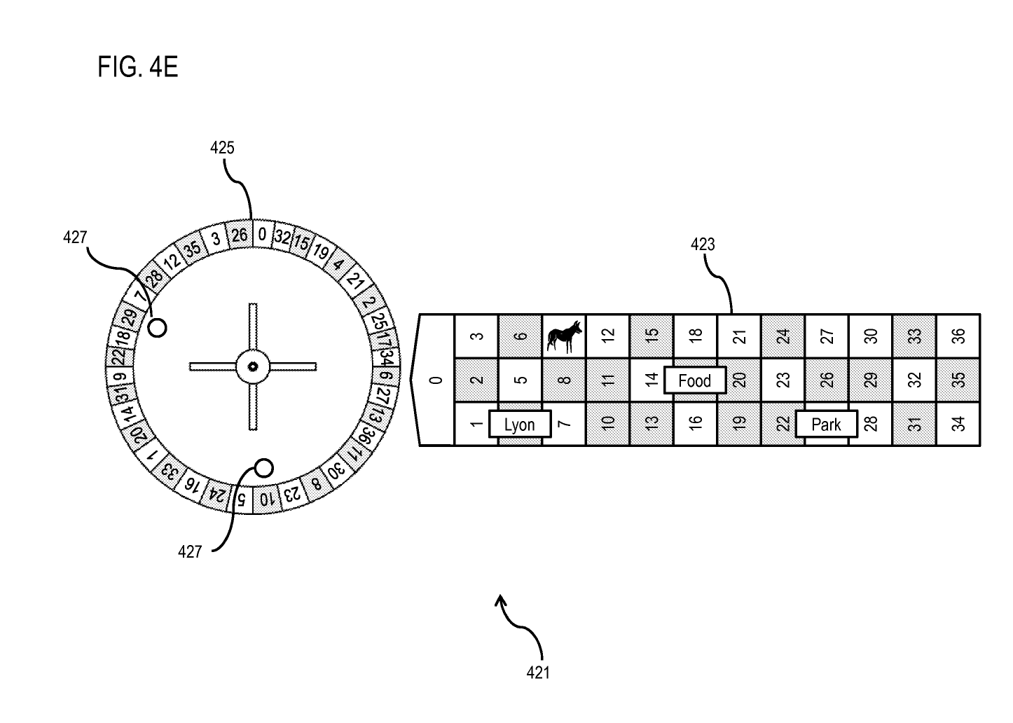

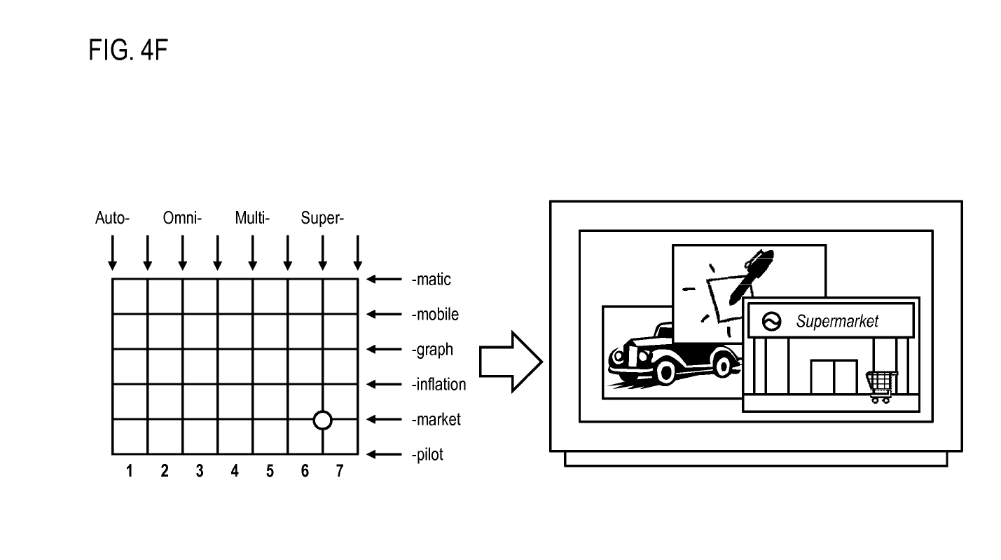

FIGS. 4A-4F are diagrams of user interfaces utilized in the processes of FIG. 3, according to various embodiments. FIG. 4A illustrates a user interface 401a of a device 400 (e.g., a UE 101) based on an initial setup of an application 111 interfacing with the user interface platform 103. As discussed above, the user interface 401a includes inputs 403, 405 that allow a user to generate and/or select, for example, parameters for user interface interaction. By way of example, parameters are arranged about a user interface modeled as an instrument-type interface, for example, a guitar fretboard. Parameters based on a first category are arranged at 6 loci representative of, for example, strings 405. For example, each category is defined about a categorical dimension. Parameters based on a second category are arranged at 5-10 loci representative of, for example, frets 403.

In certain embodiments, each individual string and each individual fret is associated and mapped to a specific parameter. Each particular grouping of frets and strings represent, for example, a parameter category presented as a categorical dimension. In certain embodiments, a first parameter category may indicate geographic locations, such as, for example, different cities as illustrated in FIG. 4A. A second parameter category may indicate certain topics or keywords as illustrated in FIG. 4A. In certain embodiments, each topic or keyword is derived from information associated with stored information. For example, parameters are derived from the stored photo selection of a user (i.e. geographic locations derived from photo geo-tags and topic/keywords derived from stored photo topics) and rendered about a user interface.

Further, FIG. 4A, for example, illustrates a two-dimensional parameter user interface embodied, for example, as a guitar fretboard. In certain embodiments, the user interface includes an X/Y graphical grid-type presentation of associated parameters. Each X/Y intersection point or vertex represents an association between the first dimension “X” category and the second dimension “Y” category. Each X/Y intersection point or vertex represents a parameter combination that a user may select on a user interface to cause, at least in part, an action. In certain embodiments, an action may include an animated but interactively controlled slideshow animation presented on, for example, an external display 401b, wherein each user interaction with a user interface (e.g., user strum) sends a photo to an external display. In certain embodiments, guitar sounds could be produced by user interaction at the interface, simulating sound production on an actual guitar instrument.

In certain embodiments, a guitar interface simulates the sound-producing mechanisms of an actual guitar instrument so, that the type of chord (e.g., at simplest: major or minor chord) defines the type or mood of images (at simplest: bright or dark) that are retrieved. The chord type is simply sent as an additional parameter to a search engine. For example, service providers or a community of users may define various mappings between the musical chord types and the descriptive/additional search parameters.

FIG. 4B illustrates a user interface 401a of a UE 101 based on an initial setup of an application 111 interfacing with the user interface platform 103. In certain embodiments, parameters associated with a categorical dimension (e.g., horizontal and vertical axes of a grid) may be defined from a map 409 or a collection of media 407 such as photos. In such an embodiment, the parameters are defined from photo metadata associated with each stored photo. The photo metadata is rendered as a parameter on a user interface via drag-and-drop interactions 411 of a user at the user interface 401a. Further, in certain embodiments, the map may include points of interest (POI), for example, cities interactively rendered on a user interface for a user to select, for example, by a drag and drop 411 interactions. The parameters may also be represented to the user visually (e.g., by established POI and other icons), as illustrated in FIG. 4B with a dog.

FIG. 4C illustrates a karaoke user interface 413 of a UE 101 based on an initial setup of an application 111 interfacing with the user interface platform 103. In certain embodiments, the parameters could be chosen from the user's music collection. For example, a “karaoke search” may be implemented, where the lyrics 417 of the currently played piece of music are shown on the grid 419 as parameters during playback of the song. The lyrics of many pieces of music are available, for example, on the internet. Various solutions exist for presenting the lyrics and the piece of music in synchrony during playback. In certain embodiments, it is ultimately up to the user to chose which combinations of parameters are selected (e.g., sent to a search engine, or used or rendered to initiate an action) and when the action is to be executed. For example, “karaoke search” interface 413 includes a music player 415 in a portion of the interface used, at least in part, to select, play, and control the playback of a current piece of music. The lyrics 417 of the song appear in the grid 419 so that the lyrics of the song played can be used as user interface parameters. In certain embodiments, unique words defining song lyrics are shown in a different size and color than generic words (such as “there”, “is”, “a”, and so forth). Further, in certain embodiments, as the song progresses, the lyrics scroll across the grid and presented for user selection.

FIG. 4D illustrates a three-dimensional user interface 429 of a UE 101 based on an initial setup of an application 111 interfacing with the user interface platform 103. In certain embodiments, the two or more grids may be overlaid, or placed on top of each other, for implementing a three-dimensional interface. In certain embodiments, there are two grids: one presenting parameters from Categories A and B, and another presenting parameters from Categories C and D. In certain embodiments, the second, or overlaid grid, is implemented through touch hovering or some other technology for detecting the user's finger above a display. Alternatively, the second, or overlaid grid, may be implemented through pressure, i.e. pressing the touch screen harder. In certain embodiments, the parameters in the second, or overlaid grid, may belong to the same category as in the first, or base grid (e.g. when a predefined category contains more parameters that can be placed in one axis of a grid). The user interface 429 may display to the user which points (from which grid) are currently selected. In certain embodiments, points from two layers may be chosen simultaneously. Further, depending on available touch screen technology, there may be more than two grids (e.g., three dimensional, four dimensional, . . . nth dimensional, etc.) available at one time and selections can be made at one time from more than one grid defining a user interface presented on one or more devices.

FIG. 4E illustrates a user interface 421 of a UE 101 based on an initial setup of an application 111 interfacing with the user interface platform 103. In certain embodiments, the search interface may be also another type of X/Y grid other than a guitar fretboard as previously discussed. The grid interface 423, could for example, also be similar to a roulette table as shown in FIG. 4E. The user(s) would select or generate parameters or images to be rendered on a grid. Further, search parameters are determined and content is retrieved from a search engine or executable actions initiated based on the random number and color a ball 427 lands on a roulette wheel 425. The interaction for initiating the search would thus be spinning the roulette wheel 425 and/or spinning a ball 427. In certain embodiments, a “roulette table” interface 421 functions as a playful semi-random interface for searching content and/or executing actions. In certain embodiments, a “roulette table” interface 421 may be used by multiple users or players simultaneously to initiate a user action at a single UE or multiple UE.

FIG. 4F illustrates a user interface 401a of a UE 101 based on an initial setup of an application 111 interfacing with the user interface platform 103. In certain embodiments, the user interface may embody an educational game, where one axis or categorical dimension contains prefixes of words and the other axes contains suffixes or words (see FIG. 4F). Complete words are formed by a user pressing a certain loci or “fret” (for prefix) and strumming a certain loci or “string” (for suffix). Images or other media items (e.g., music or sounds) matching the thus formed word are shown to the user as results of, for example, a display, search, function, or combination thereof. In case the user makes a mistake and forms a word that doesn't make sense, the search doesn't produce a result or reinforcing action. In certain embodiments, the educational game may present the user a word in her native language and challenge the user to translate the word into another language by using, for example, a guitar interface. In certain embodiments, multiple users on a plurality of devices may be engaged in the game at once or in turn competing as teams and/or opponents. In certain embodiments, first an image is shown to the user, and then the user has to state what is shown in the image by forming a word by pressing the point between the correct prefix and suffix as shown in FIG. 4F.

The processes described herein for enabling efficient multi-parameter discovery and input may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

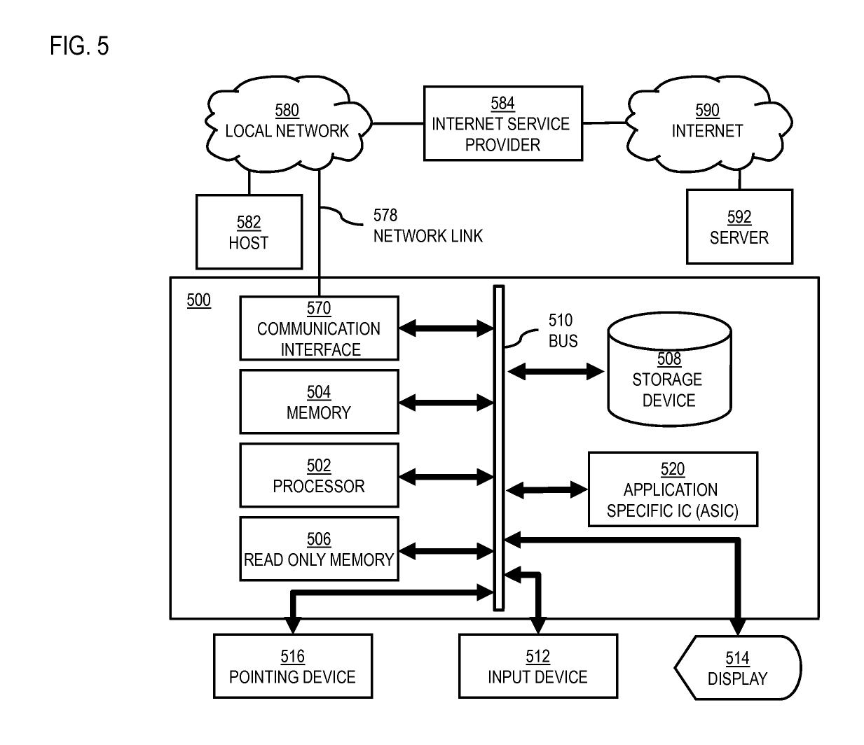

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to enable efficient multi-parameter discovery and input, as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of enabling efficient multi-parameter discovery and input.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to enabling efficient multi-parameter discovery and input. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or any other dynamic storage device, stores information including processor instructions for enabling efficient multi-parameter discovery and input. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or any other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for enabling efficient multi-parameter discovery and input is provided to the bus 510 for use by the processor from an external input device 512, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT), a liquid crystal display (LCD), a light emitting diode (LED) display, an organic LED (OLED) display, a plasma screen, or a printer for presenting text or images, and a pointing device 516, such as a mouse, a trackball, cursor direction keys, or a motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of ASICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 105 for enabling efficient multi-parameter discovery and input to the UE 101.

The term “computer-readable medium” as used herein refers to any medium that participates in providing information to processor 502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or any other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

FIG. 6 illustrates a chip set or chip 600 upon which an embodiment of the invention may be implemented. Chip set 600 is programmed to enable enabling efficient multi-parameter discovery and input as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of functions. Chip set or chip 600, or a portion thereof, constitutes a means for performing one or more steps of enabling efficient multi-parameter discovery and input.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to enable efficient multi-parameter discovery and input. The memory 605 also stores the data associated with or generated by the execution of the inventive steps.

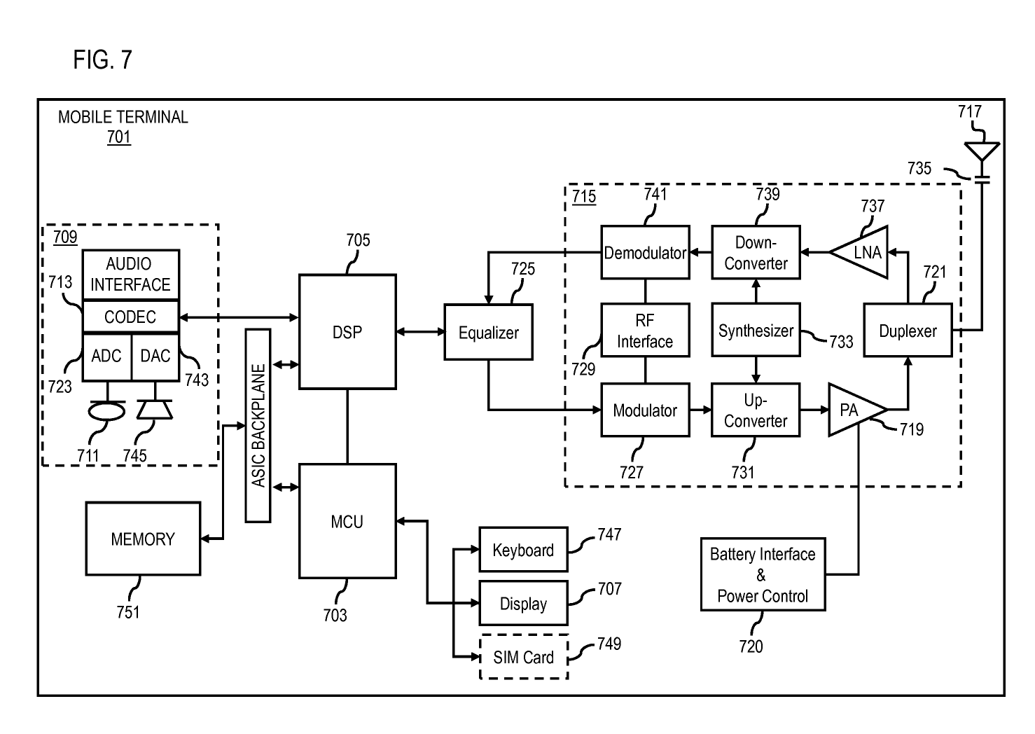

FIG. 7 is a diagram of exemplary components of a mobile terminal (e.g., handset) for communications, which is capable of operating in the system of FIG. 1, according to one embodiment. In some embodiments, mobile terminal 701, or a portion thereof, constitutes a means for performing one or more steps of enabling efficient multi-parameter discovery and input. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps of enabling efficient multi-parameter discovery and input. The display 707 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703 which can be implemented as a Central Processing Unit (CPU).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to enable efficient multi-parameter discovery and input. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
at least one determination to generate a user interface presenting one or more representations of one or more parameters associated with at least one categorical dimension;
one or more manipulations of the one or more representations in the user interface; and
a processing of the one or more manipulations to select from among the one or more parameters, the at least one categorical dimension, or a combination thereof.

2. A method of claim 1, wherein the (1) data and/or (2) information and/or (3) at least one signal are further based, at least in part, on the following:
an initiation of at least one action, at least one function, or a combination thereof based, at least in part, on the selected one or more parameters, the selected at least one categorical dimension, or a combination thereof.

3. A method of claim 2, wherein the (1) data and/or (2) information and/or (3) at least one signal are further based, at least in part, on the following:
a processing of the one or more manipulations to determine at least one initiation interaction,
wherein the initiation of the at least one action, the at least one function, or a combination thereof is based, at least in part, on the at least one initiation interaction.

4. A method of claim 1, wherein the (1) data and/or (2) information and/or (3) at least one signal are further based, at least in part, on the following:
at least one determination of the one or more parameters, the at least one categorical dimension, or a combination thereof based, at least in part, on a user-generated list, a predetermined list, a random selection, or a combination thereof.

5. A method of claim 1, wherein the (1) data and/or (2) information and/or (3) at least one signal are further based, at least in part, on the following:
at least one determination to present the user interface on a multi-touch enabled device,
wherein the one or more manipulations comprises, at least in part, interaction information with one or more points on the multi-touch enabled device.

6. A method of claim 5, wherein the (1) data and/or (2) information and/or (3) at least one signal are further based, at least in part, on the following:
a processing of the interaction information to determine one or more coordinates, one or more frequencies, one or more touch-pressure levels, or a combination thereof of the one or more manipulations; and
at least one determination of one or more rendering characteristics of the user interface, the one or more representations, or a combination thereof the one or more based, at least in part, on the one or more coordinates, the one or more frequencies, the one or more touch-pressure levels, or a combination thereof.

7. A method of claim 1, wherein the (1) data and/or (2) information and/or (3) at least one signal are further based, at least in part, on the following:
context information associated with one or more devices presenting the user interface; and
a processing of the context information to determine the one or more parameters, the at least one categorical dimension, or a combination thereof.

8. A method of claim 1, wherein the (1) data and/or (2) information and/or (3) at least one signal are further based, at least in part, on the following:
a presentation of the user interface on a plurality of devices,
wherein the one or more manipulations are determine with respect to the plurality of devices.

9. A method of claim 1, wherein the (1) data and/or (2) information and/or (3) at least one signal are further based, at least in part, on the following:
a rendering of the one or more representations as at least one musical instrument interface, at least one grid interface, at least one karaoke interface, at least one media player interface, at least one educational tool interface, at least one game interface, at least one roulette table interface, or a combination thereof.

10. A method of claim 1, wherein the (1) data and/or (2) information and/or (3) at least one signal are further based, at least in part, on the following:
an initiation of a search, an application activity, an executable command, or a combination thereof based, at least in part, on the selected one or more parameters, the selected at least one categorical dimension, or a combination thereof.

11. An apparatus comprising:
at least one processor; and
at least one memory including computer program code for one or more programs,
the at least one memory and the computer program code configured to, with the at least one processor, cause the apparatus to perform at least the following,
determine to generate a user interface presenting one or more representations of one or more parameters associated with at least one categorical dimension;
determine one or more manipulations of the one or more representations in the user interface; and
process and/or facilitate a processing of the one or more manipulations to select from among the one or more parameters, the at least one categorical dimension, or a combination thereof.

12. An apparatus of claim 11, wherein the apparatus is further caused to:
cause, at least in part, an initiation of at least one action, at least one function, or a combination thereof based, at least in part, on the selected one or more parameters, the selected at least one categorical dimension, or a combination thereof.

13. An apparatus of claim 12, wherein the apparatus is further caused to:
process and/or facilitate a processing of the one or more manipulations to determine at least one initiation interaction,
wherein the initiation of the at least one action, the at least one function, or a combination thereof is based, at least in part, on the at least one initiation interaction.

14. An apparatus of claim 11, wherein the apparatus is further caused to:
determine the one or more parameters, the at least one categorical dimension, or a combination thereof based, at least in part, on a user-generated list, a predetermined list, a random selection, or a combination thereof.

15. An apparatus of claim 11, wherein the apparatus is further caused to:
determine to present the user interface on a multi-touch enabled device,
wherein the one or more manipulations comprises, at least in part, interaction information with one or more points on the multi-touch enabled device.

16. An apparatus of claim 15, wherein the apparatus is further caused to:
process and/or a facilitate a processing of the interaction information to determine one or more coordinates, one or more frequencies, one or more touch-pressure levels, or a combination thereof of the one or more manipulations; and
determine one or more rendering characteristics of the user interface, the one or more representations, or a combination thereof the one or more based, at least in part, on the one or more coordinates, the one or more frequencies, the one or more touch-pressure levels, or a combination thereof.

17. An apparatus of claim 11, wherein the apparatus is further caused to:
determine context information associated with one or more devices presenting the user interface; and
process and/or facilitate a processing of the context information to determine the one or more parameters, the at least one categorical dimension, or a combination thereof.

18. An apparatus of claim 11, wherein the apparatus is further caused to:
cause, at least in part, a presentation of the user interface on a plurality of devices,
wherein the one or more manipulations are determine with respect to the plurality of devices.

19. An apparatus of claim 11, wherein the apparatus is further caused to:
cause, at least in part, a rendering of the one or more representations as at least one musical instrument interface, at least one grid interface, at least one karaoke interface, at least one media player interface, at least one educational tool interface, at least one game interface, at least one roulette table interface, or a combination thereof.

20. An apparatus of claim 11, wherein the apparatus is further caused to:
cause, at least in part, an initiation of search, application activity, executable command, or a combination thereof based, at least in part, on the selected one or more parameters, the selected at least one categorical dimension, or a combination thereof.
